(19) United States
(12) Patent Application Publication
(10) Pub. No.: US 2023/0383841 A1
(43) Pub. Date: Nov. 30, 2023

(54) FIXING CLIP, SEALING STRIP AND WEAVING METHOD THEREOF

(71) Applicant: SILCATEX LANGFANG MATERIAL CO., LTD, Langfang (CN)

(72) Inventor: Enhua QIU, Langfang (CN)

(21) Appl. No.: 18/303,611

(22) Filed: Apr. 20, 2023

(30) Foreign Application Priority Data
May 27, 2022 (CN) 202210594079.X

(51) Int. Cl. F16J 15/06; F16B 2/24

(52) U.S. Cl. CPC F16J 15/061; F16B 2/248

(57) ABSTRACT

Provided are a fixing clip, a sealing strip and a weaving method thereof. The fixing clip is formed by bending a single metal wire, and the fixing clip comprises a head portion, a first bottom portion and a second bottom portion; the first bottom portion and the second bottom portion are respectively connected with two ends of the head portion; the head portion is in a quadrangular diamond shape, and the head portion, the first bottom portion and the second bottom portion all comprise a round tip; and at least one of the round tip of the first bottom portion and the round tip of the second bottom portion are bent towards the round tip of the head portion.

### CROSS REFERENCE TO RELATED APPLICATIONS

This application claims foreign priority of Chinese Patent Application No. 202210594079.X, filed on May 27, 2022 in the China National Intellectual Property Administration, the disclosures of all of which are hereby incorporated by reference.

### TECHNICAL FIELD

The present invention relates to a fixing clip, a sealing strip and a weaving method thereof.

### BACKGROUND OF THE PRESENT INVENTION

Household appliances, such as ovens, refrigerators and washing machines, all need strip sealing materials to ensure good sealing effects of doors, windows and boxes when closed. However, how to effectively ensure the sealing performance and fix the sealing materials on the above equipment in the most economical way is a subject that has been continuously studied. Particularly, in the general trends of reducing emission and improving the energy-saving level of the household appliances, the sealing performance of doors, windows and boxes plays one of key factors. Taking the oven as an example, if the door, the window and the box have good air tightness, heat can be retained in an inner container when the equipment is operated, which can greatly reduce the energy consumption of the equipment.

The production of the household appliances is mostly made by automatic production lines, but the sealing strips are completely mounted by manual operation. It is a necessary improvement to increase a mounting speed of the sealing strip, grab a clip on the sealing strip quickly, and insert the clip into a mounting hole.

When the position misalignment of the mounting hole caused by a manual mounting error inevitably occurs on a mounting assembly line, it is necessary to pull the clip out and mount the clip in an accurate position again. Therefore, the clip of the sealing strip needs to be detachable.

As shown in FIG. 1, the U.S. Pat. No. 6,893,025B2 (authorization date: May 17, 2005) discloses a fixing clip 10 made of a single metal wire, which is provided with a head portion 14 (the head portion 14 comprises a vertex 14a, a shoulder 14b and a tail end 14c of the head portion) and a coil 12 perpendicular to the head portion, wherein the head portion 14 is used for being inserted into a corresponding mounting hole in the oven box, and the coil 12 is used for hooking the sealing strip. The coil 12 of the clip is provided with an inserting end 12d for being inserted into a surface layer of the sealing strip, and then is manually rotated into an inner cavity of the sealing strip.

The inserting end 12d of the clip is located at a lowest part of the coil 12, and forms an included angle with a bottom surface of the coil 12, which is convenient for inserting the clip into the surface of the sealing strip and then rotating the clip into the inner cavity. When the door and the window are closed, the sealing strip is squeezed to easily hook the other side of the sealing strip (located on an insulation layer opposite to the clip), so that the sealing strip cannot play a role of sealing normally. An overall thickness of the coil 12 is relatively thick. Because a base of the clip needs to be provided with the coil 12, which occupies a space, once a mounting surface of the door, the window or the box is uneven, it is easy to cause untight closing of the door and the window due to blocking of the clip. Because the coil 12 has a spiral structure, it is easy to damage the insulation layer during rotation, resulting in a poor sealing effect.

As shown in FIG. 2, the Chinese patent CN200710164481.X also discloses a clip for fixing a sealing strip or a similar device on a mounting surface, which comprises a head portion 10 fitted with the mounting surface, a neck portion 20 and an annular base 30 perpendicular to the head portion and connected with the neck portion. The head portion 10 is provided with a relatively sharp top portion 11, a pair of shoulder portions 12 and a tail end 13. The annular base 30 is perpendicular to a plane where the head portion 10 is located, and is provided with a wave-shaped protrusion 33 at a terminative part of an annulus, a plane formed by a wave is also perpendicular to the base, the other tail end 32 of the metal wire is a terminative end of the wave, which is close to a starting end 31 of the annulus, with a gap of 0.3 mm to 0.4 mm, and is located on the same plane as the base.

This type of clip is very difficult to operate during mounting: in order to pierce the clip into the surface of the sealing strip, it is necessary to squeeze the protrusion 33 first, and then the clip is pierced and rotated. The protrusion 33 cannot be loosened before rotation, otherwise the tail end 32 will retreat from the surface of the sealing strip. The surface of the sealing strip is very likely to be damaged during rotation, resulting in a poor sealing effect. The requirements for operators are very high in this rotation process, and the operation is inconvenient.

The bases of the above two fixing clips are both annular, and the head portions of the clips may still be rotated at will after being mounted in the inner cavity of the sealing strip, without directionality. Users need to readjust and align the clip and then insert the clip into the mounting hole when mounting the clip in the oven box. Because an outer diameter of the sealing strip usually ranges from 9 mm to 11 mm, an annular diameter of the base of the clip cannot be too large. Therefore, it is very difficult for the users to grasp this type of clip during mounting, resulting in more labor consumption on a mounting site.

As shown in FIG. 3, the Chinese patent CN102297193A discloses a steel wire hook, which comprises a head portion 1 and a bottom portion 2 which are made of metal wires, wherein the head portion 1 and the bottom portion 2 are connected together, planes where the head portion 1 and the bottom portion 2 are located are perpendicular to each other, the bottom portion (2) is provided with a long leg 2-1 bent inwardly, and a large gap exists between the long leg 2-1 and a main body of the bottom portion 2.

Although the Chinese patent CN102297193A can solve the above problems, it is practically proved that the mounting of this type of clip is very troublesome. Because a design structure of the base is an open loop, when the clips are in a packaging bag, the base of the clip and the head portion of the adjacent clip, and the base of the clip and the base of the adjacent clip are intertwined, interpenetrated and hooked together. Common packing modes of manufacturers of clips comprise bag packaging or box packaging. Many times of shaking are inevitable during transportation or carrying, and the clips are tangled with each other and cannot be screened and disentangled after such turning over.

In addition to the above disadvantages, the three types of clips mentioned above all have one structural design disadvantage. Once the clip is pushed into the mounting hole, the clip cannot be disassembled. Unless the sealing strip is forcibly pulled out with the clip, the clip can be disassembled. In this way, the clip and the sealing strip may both be seriously and irreparably damaged, resulting in deformation and incapability of reuse. As shown in FIGS. 4A-4C, once the clip is pushed into the mounting hole, the clip can only be pulled down by a force to be disassembled. However, because there is only a single link connected between the head portion and the base of the clip, once the sealing strip is pulled down, a pulling force on an outer layer of the sealing strip may be transferred to the head portion through a joint, so that a clamping shoulder of the head portion may shift to an unconnected side, and a tail end of the metal wire forming the head portion will be bent upwardly due to blocking of a panel at the moment, resulting in overall deformation.

The above types of clips are all embedded into the inner cavity of the sealing strip by manual rotation after weaving. This method can only be realized on a hollow sealing strip. In the case of a solid sealing strip with a thermal insulation filler inside, the clip cannot be embedded into the sealing strip through subsequent rotation due to the blocking of the filler.

The mounting method requires a lot of tedious manual operations. A plurality of fixing clips should be mounted on one sealing strip. For example, a sealing strip with a length of 1.7 m is usually used in a 75 L household oven, and assuming that a distance between the clips is 60 mm, 28 clips are needed. Each clip needs to be accurately mounted in a pre-designed corresponding position, otherwise there is a risk that the clip of the sealing strip will be misaligned with the mounting hole in the oven box. Therefore, operators need to finish positioning first, pierce all clips into the surface of the sealing strip to avoid dislocation, and then rotate the clips into the inner cavity of the sealing strip one by one. This type of work is very tedious and time-consuming.

### SUMMARY OF PRESENT INVENTION

The present invention aims to provide a fixing clip, a sealing strip and a weaving method thereof, belonging to a closed-loop design and saving time.

The present invention provides a fixing clip formed by bending a single metal wire, wherein the fixing clip comprises a head portion, a first bottom portion and a second bottom portion; the first bottom portion and the second bottom portion are respectively connected with two ends of the head portion; the head portion is in a quadrangular diamond shape, and the head portion, the first bottom portion and the second bottom portion all comprise a round tip; and at least one of the round tip of the first bottom portion and the round tip of the second bottom portion is bent towards the round tip of the head portion.

Preferably, the round tip of the head portion is called a head round tip; and the head portion further comprises a first head bending section connected with one end of the head round tip, a second head bending section connected with the other end of the head round tip and a first horizontal section connected with the first head bending section.

Preferably, the round tip of the first bottom portion and the round tip of the second bottom portion are both called a bottom round tip; the first bottom portion and the second bottom portion are symmetrically arranged, and the first bottom portion and the second bottom portion both comprise a first bottom bending section connected with one side of the bottom round tip and a second bottom bending section connected with the other side of the bottom round tip; and the first bottom portion further comprises a second horizontal section connected with the second bottom bending section, and the second bottom portion further comprises a third horizontal section connected with the second bottom bending section.

Preferably, a tail end of the first horizontal section of the head portion is connected with the first bottom bending section of the second bottom portion; and an intersection between the head portion and the first bottom portion, the first horizontal section, the second horizontal section and the third horizontal section are sequentially arranged in parallel, and the second horizontal section and the third horizontal section are two ends of the metal wire forming the fixing clip respectively.

Preferably, the round tip of the first bottom portion and the round tip of the second bottom portion are called the bottom round tip; and the first bottom portion and the second bottom portion both comprise a first arc-shaped end and a first curved end which are connected with two ends of the bottom round tip and symmetrically arranged.

Preferably, one end of the head portion is connected with one end of the first bottom portion in a crossed manner to form a first intersection, and the other end of the head portion is connected with one end of the second bottom portion in a crossed manner to form a second intersection; and the other end of the first bottom portion and the other end of the second bottom portion are two ends of the metal wire respectively, the other end of the first bottom portion and the other end of the second bottom portion are attached together to form a first attached part, and the first intersection, the second intersection and the first attached part are arranged in parallel and closely attached to each other.

Preferably, two ends of the head portion are respectively connected with one end of the first bottom portion and one end of the second bottom portion in a crossed manner and form a first intersection; and the other end of the first bottom portion and the other end of the second bottom portion are two ends of the metal wire respectively, the other end of the first bottom portion and the other end of the second bottom portion are attached together to form a first attached part, a gap exists between the first intersection and the first attached part, and the gap communicates the first bottom portion with the second bottom portion.

Preferably, two ends of the head portion are respectively connected with one end of the first bottom portion and one end of the second bottom portion in a non-crossed manner, and a joint between the head portion and the first bottom portion and a joint between the head portion and the second bottom portion are adjacent; and one end of the metal wire is the other end of the first bottom portion, the other end of the metal wire is the other end of the second bottom portion, and two opposite ends of the metal wire have a gap or are attached together.

Preferably, at least one of the first bottom portion and the second bottom portion is provided with a protrusion extending towards the head portion.

The present invention further provides a sealing strip, wherein the sealing strip is a solid or hollow sealing strip, and the sealing strip is provided with a plurality of fixing clips.

The present invention further provides a weaving method of a sealing strip, wherein the sealing strip comprises an inner core and an insulation layer wound on the inner core, the insulation layer is formed by weaving yarns through the fixing clip, and the weaving method comprises: inserting the first bottom portion or the second bottom portion of the fixing clip into fibers crossed with each other, and bringing the other bottom portion into the fibers by the yarns along with weaving.

Preferably, the first bottom portion and the second bottom portion form an included angle less than 90 degrees with a pulling direction during inserting.

According to the present invention, the fixing clip is provided with the first bottom portion and the second bottom portion which are symmetrically design, so that the clip is avoided from being scrapped due to damage by unilateral stress on the head portion during disassembling; the first bottom portion and the second bottom portion can reduce a diagonal distance of the head portion by pulling left and right or squeezing inwardly, and then the clip is pulled out without damage by easily pulling outwardly; and because an overall design of the bottom portion belongs to a closed loop, the fixing clips are not intertwined with each other during transportation of the clips, thus avoiding a tedious disentangling work of an operator.

### DESCRIPTION OF THE DRAWINGS

FIG. 1 is a schematic structural diagram of the existing U.S. Pat. No. 6,893,025B2;

FIG. 2 is a schematic structural diagram of the existing Chinese patent CN200710164481.X;

FIG. 3 is a schematic structural diagram of the existing Chinese patent CN102297193A;

FIGS. 4A-4C are schematic diagrams of mounting of an existing clip;

FIG. 5 to FIG. 7 are schematic structural diagrams of a fixing clip in First Embodiment of the present invention;

FIG. 8 is a schematic structural diagram of a fixing clip in Second Embodiment of the present invention;

FIG. 9 is a schematic structural diagram of a fixing clip in Third Embodiment of the present invention;

FIG. 10 and FIG. 11 are schematic structural diagrams of a fixing clip in Fourth Embodiment of the present invention;

FIG. 12 and FIG. 13 are schematic structural diagrams of a fixing clip in Fifth Embodiment of the present invention;

FIG. 14 to FIG. 15 are schematic structural diagrams of a fixing clip in Sixth Embodiment of the present invention;

FIG. 16 is a schematic diagram of the fixing clip mounted synchronously with weaving;

FIGS. 17A-17B are schematic structural diagrams of a hollow sealing strip in the embodiment of the present invention;

FIGS. 18A-18B are schematic structural diagrams of a solid sealing strip in the embodiment of the present invention; and

FIG. 19 is a schematic structural diagram of a central plane of the fixing clip in the embodiment of the present invention.

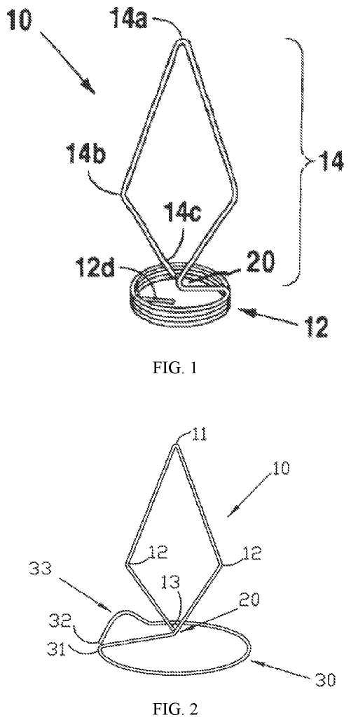

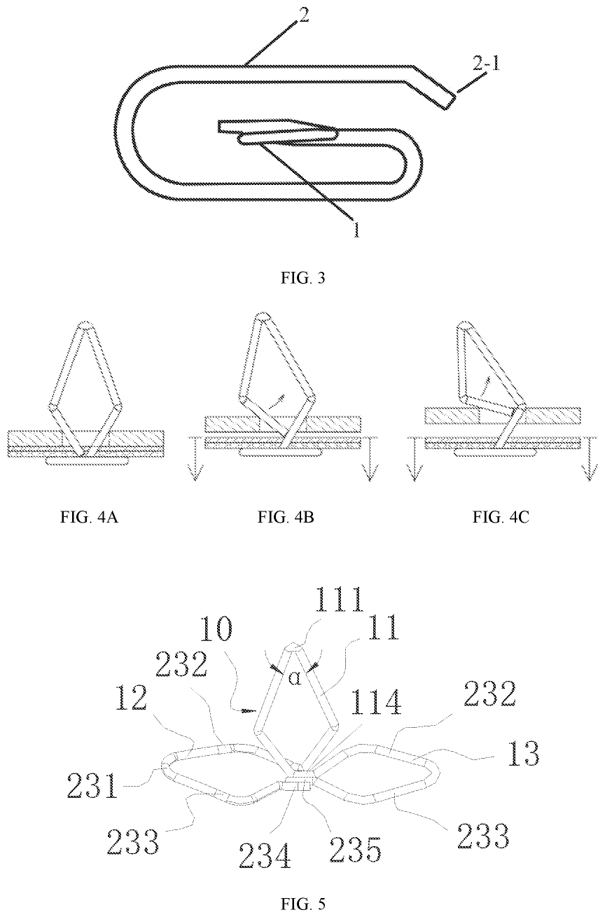

### DETAILED DESCRIPTION OF PREFERRED EMBODIMENTS

To make the objects, the technical solutions and the advantages of the present invention clearer, the present invention is further described in detail hereinafter with reference to the drawings and the embodiments. It should be understood that the specific embodiments described herein are only used for explaining the present invention, and are not intended to limit the present invention.

### First Embodiment

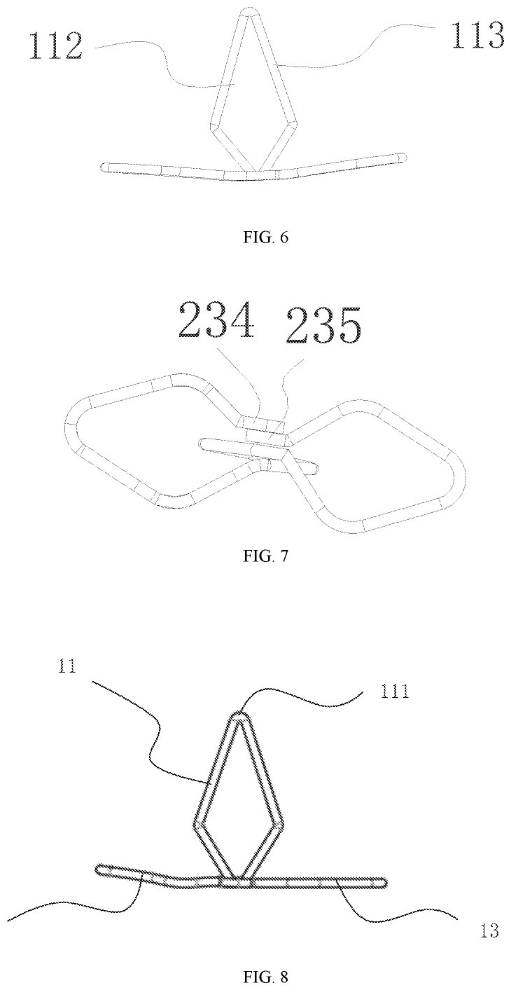

The present invention discloses a fixing clip used for a sealing strip. FIG. 5 to FIG. 7 are schematic structural diagrams of First Embodiment of the present invention, the fixing clip 10 is formed by bending a single metal wire, and the fixing clip 10 comprises a head portion 11, a first bottom portion 12 and a second bottom portion 13. The first bottom portion 12 and the second bottom portion 13 are respectively connected with two ends of the head portion 11; and the head portion 11, the first bottom portion 12 and the second bottom portion 13 are all in a quadrangular diamond shape.

The head portion 11 is a symmetrical quadrangle, which comprises a head round tip 111, a first head bending section 112 connected with one side of the head round tip 111, a second head bending section 113 connected with the other side of the head round tip 111 and a first horizontal section 114 connected with the first head bending section 112. An angle of the head round tip 111 is an acute angle α, α preferably ranges from 25 degrees to 45 degrees, and the head round tip 111 is oriented to a mounting hole in a box. The first head bending section 112 and the second head bending section 113 are symmetrically arranged relative to a center line of the head round tip 111, the first head bending section 112 and the second head bending section 113 are both formed by bending two segments of lines, and angles of bending parts of the first head bending section 112 and the second head bending section 113 are both an obtuse angle, and preferably range from 120 degrees to 140 degrees. The first horizontal section 114 is connected with the second bottom portion 13 at a tail end, the first head bending section 112 is connected with the second bottom portion 13 at a tail end, and the first horizontal section 114 is located on an inner side of the second head bending section 113.

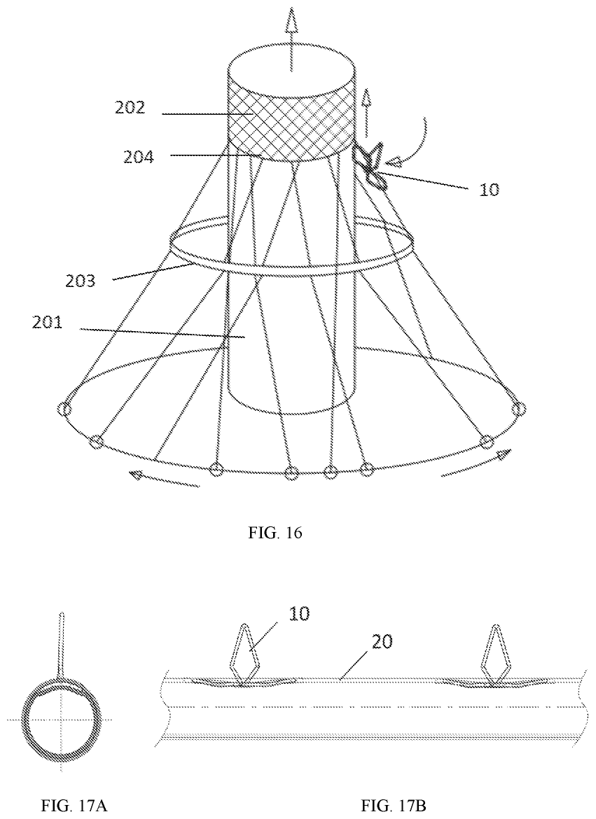

The first bottom portion 12 and the second bottom portion 13 are also symmetrical quadrangles, and the first bottom portion 12 and the second bottom portion 13 are symmetrically arranged. The first bottom portion 12 and the second bottom portion 13 both comprise a bottom round tip 231, a first bottom bending section 232 connected with one end of the bottom round tip 231 and a second bottom bending section 233 connected with the other end of the bottom round tip 231. The first bottom portion 12 further comprises a second horizontal section 234 connected with the second bottom bending section 233, and the second bottom portion 13 further comprises a third horizontal section 235 connected with the second bottom bending section 233. The bottom round tips 231 of the first bottom portion 12 and the second bottom portion 13 are both bent towards the head round tip 111 of the head portion 11, so that in order to prevent the sealing strip from sagging and achieve a better sealing effect, at least one of the first bottom portion 12 and the second bottom portion 13 is provided with a curved surface on a cross section to tightly hold an inner core 201 (as shown in FIG. 16), which means that in order to make the sealing strip closer to the oven box and improve the sealing effect, the head portion 11 is inserted into the mounting hole in the box and then clamped in the hole through lower parts of the first head bending section 112 and the second head bending section 113. However, the mounting hole may have various sizes in the case of low accuracy, and once an aperture of the mounting hole is too large, the fixing clip may be loosened, leading to sagging of the sealing strip and outward slipping of the fixing clip. If there are parts of the first bottom portion 12 and the second bottom portion 13 bent towards the head portion 11, the larger aperture may be compensated, thus avoid the above situation.

The head round tip 111 and the bottom round tip 231 are better when being smoother, thus being convenient for mounting.

A tail end of the first horizontal section 114 of the head portion 11 is connected with the first bottom bending section 232 of the second bottom portion 13; and an intersection between the head portion 11 and the first bottom portion 12, the first horizontal section 114, the second horizontal section 234 and the third horizontal section 235 are sequentially arranged in parallel, and the second horizontal section 234 and the third horizontal section 235 are two ends of the metal wire forming the fixing clip respectively.

An angle of the bottom round tip 231 is also an acute angle, the first bottom bending section 232 and the second bottom bending section 233 are both formed by bending two segments of lines, and angles of bending parts of the first bottom bending section 232 and the second bottom bending section 233 are both an obtuse angle.

The metal wire is bent to form the bottom round tip 231 of the first bottom portion 12 or the second bottom portion. Taking the bottom round tip 231 of the first bottom portion 12 as an example, the metal wire is bent towards two sides along the bottom round tip 231 of the first bottom portion 12 to form the first bottom bending section 232 of the first bottom portion 12 and the second bottom bending section 233 of the first bottom portion 12, and one end of the metal wire forms the second horizontal section 234 connected with the second bottom bending section 233 of the first bottom portion 12. Then, the metal wire is bent upwardly to sequentially form the second head bending section 113 of the head portion 11, the first head bending section 112 of the head portion 11 and the first horizontal section 114 of the head portion 11, and form the head round tip 111 between the second head bending section 113 and the first head bending section 112. After the head portion 11 is finished, the metal wire returns to a plane where the bottom portion is located, and is continuously bent to form the second bottom portion 13: the metal wire is bent to form the first bottom bending section 232 of the second bottom portion 13 connected with the first horizontal section 114 of the head portion 11 first, then is bent to form the second bottom bending section 233 of the second bottom portion 13 connected with the first bottom bending section 232 of the second bottom portion 13, finally forms the third horizontal section 235 of the second bottom portion 13, and forms the bottom round tip 231 of the second bottom portion 13 between the first bottom bending section 232 of the second bottom portion 13 and the second bottom bending section 233 of the second bottom portion 13, the third horizontal section 235 of the second bottom portion 13 is inserted between the first horizontal section 114 of the head portion 11 and the second horizontal section 234 of the first bottom portion 12, and the third horizontal section 235 of the second bottom portion 13 is the other end of the metal wire.

### Second Embodiment

FIG. 8 is a schematic structural diagram of Second Embodiment of the present invention, and a difference between Second Embodiment and First Embodiment above is that: the bottom round tip 231 of the first bottom portion 12 or the bottom round tip 231 of the second bottom portion 13 is bent towards the head round tip 111 of the head portion 11, thus forming a fixing clip with a single curved surface.

### Third Embodiment

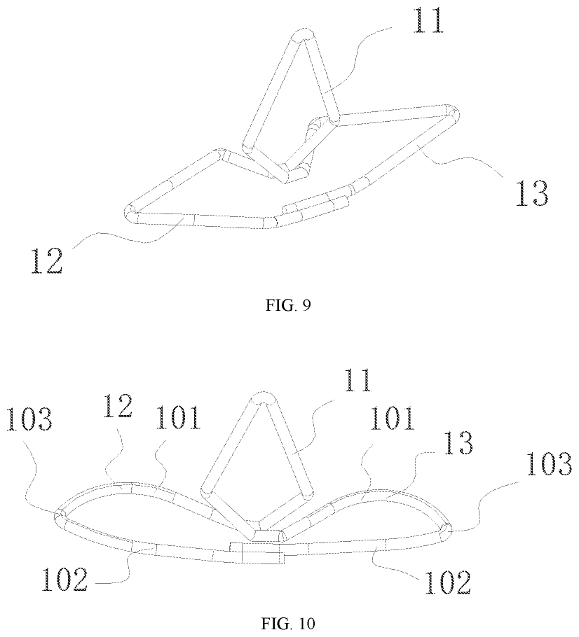

FIG. 9 is a schematic structural diagram of Third Embodiment of the present invention, and a difference between Third Embodiment and First Embodiment above is that: two ends of the head portion 11 are respectively connected with one end of the first bottom portion 12 and one end of the second bottom portion 13 in a crossed manner and form a first intersection; and the other end of the first bottom portion 12 and the other end of the second bottom portion are two ends of the metal wire respectively, the other end of the first bottom portion 12 and the other end of the second bottom portion are attached together to form a first attached part, a gap exists between the first intersection and the first attached part, and the gap communicates the first bottom portion 12 with the second bottom portion 13.

For First Embodiment above, one end of the head portion 10 is connected with one end of the first bottom portion 12 in a crossed manner to form a first intersection, and the other end of the head portion 10 is connected with one end of the second bottom portion 13 in a crossed manner to form a second intersection; and the other end of the first bottom portion 12 and the other end of the second bottom portion 13 are two ends of the metal wire respectively, the other end of the first bottom portion 12 and the other end of the second bottom portion 13 are attached together to form a first attached part, and the first intersection, the second intersection and the first attached part are arranged in parallel and closely attached to each other.

### Fourth Embodiment

FIG. 10 and FIG. 11 are schematic structural diagrams of Fourth Embodiment of the present invention, and a difference between Fourth Embodiment and First Embodiment above is that: the first bending section and the second bending section are both arc-shaped, which means that the first bottom portion 12 and the second bottom portion 13 both comprise a bottom round tip 103, and a first arc-shaped end 101 and a first curved end 102 which are connected with two ends of the bottom round tip 103 and symmetrically arranged.

The first bottom portion 12 and the second bottom portion 13 are still symmetrical quadrangles approximately, with smoother angles and longer diagonal lines in the same direction as an axial direction of the sealing strip, so that once the fixing clips are mounted in the sealing strip, the head portion 11 of each fixing clip may be kept in the same direction. The bottom round tip 103 of the first bottom portion 12 and the bottom round tip 103 of the second bottom portion 13 protrude towards the head portion of the clip.

This embodiment can achieve two goals: firstly, after the sealing strip is mounted on the box, the head portion 11, the first bottom portion 12 and the second bottom portion 13 of the fixing clip all exert a pressure on a panel of the box to achieve stress balance. Secondly, it is convenient to pre-assemble the fixing clip. The fixing clip is inserted into the sealing strip through the “round tip” during weaving, and other yarns may be translated away once the “round tip” enters an insulation layer, so that the first bottom portion 12 and the second bottom portion 13 of the whole fixing clip are completely embedded.

### Fifth Embodiment

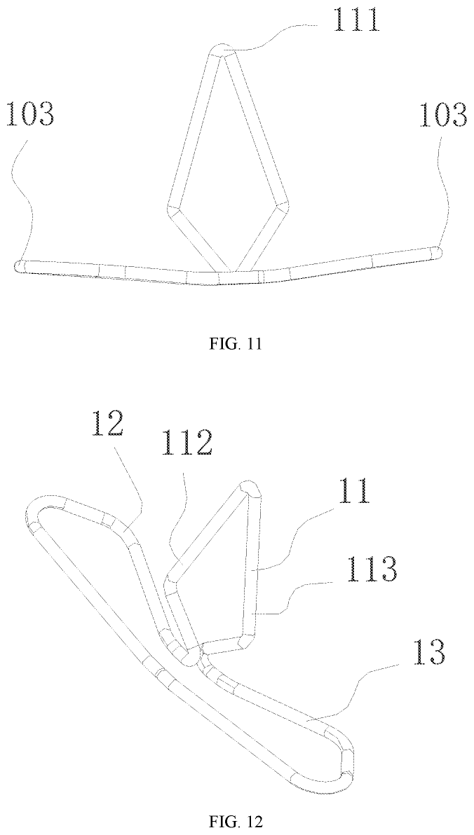

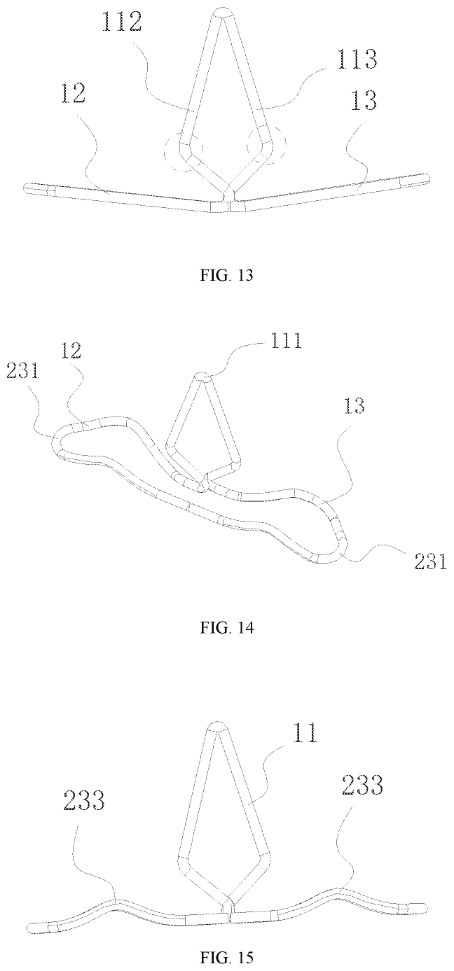

FIG. 12 and FIG. 13 are schematic structural diagrams of Fifth Embodiment of the present invention, and a difference between Fifth Embodiment and Third Embodiment above is that: two ends of the head portion 11 are respectively connected with one end of the first bottom portion 12 and one end of the second bottom portion 13 in a non-crossed manner (without needing cross connection), a joint between the head portion 11 and the first bottom portion 12 and a joint between the head portion 11 and the second bottom portion 13 are both formed by bending the metal wire, and the joint between the head portion 11 and the first bottom portion 12 and the joint between the head portion 11 and the second bottom portion 13 are close to each other. The first bottom portion 12 and the second bottom portion 13 are also communicated, and the first bottom portion 12 and the second bottom portion 13 are both bent towards the head portion 11.

One end of the metal wire is one end of the first bottom portion 12, the other end of the metal wire is one end of the second bottom portion 13, and two opposite ends of the metal wire have a gap or are attached together.

This design is intended to facilitate disassembly.

The fixing clip of this embodiment is used, and by compressing the first bottom portion 12 and the second bottom portion 13, a distance between a bending part of the first head bending section 112 and a bending part of the second head bending section 113 of the head portion 11 (as shown by circular dotted lines in FIG. 14) can be reduced, so that the fixing clip is pulled out from the mounting hole of the oven.

### Sixth Embodiment

FIG. 14 to FIG. 15 are schematic structural diagrams of Sixth Embodiment of the present invention, and a difference between Sixth Embodiment and Fifth Embodiment above is that: at least one of the first bottom portion 12 and the second bottom portion 13 is provided with protrusions 233 extending towards the head portion, and the protrusion 233 is designed to compensate for various sizes of the mounting hole of the oven.

The round tips 231 of the first bottom portion 12 and the second bottom portion 13 are not bent towards the round tip 111 of the head portion 11, so that an anti-loosening effect of other examples mentioned above can be achieved by the protrusion 233. FIG. 16 is a schematic diagram of the fixing clip mounted synchronously with weaving, the sealing strip comprises a columnar inner core 201 and an insulation layer 202 wound around the inner core 201, the insulation layer 202 is woven with yarns on a surface of the inner core 201 by the fixing clip, the insulation layer 202 is woven with fibers on the surface of the inner core 201, the fibers are the yarns, and the insulation layer 202 is formed by guiding the yarns to weave through a weaving guide ring 203.

The fixing clip 10 of the present invention may be mounted in the insulation layer 202 while weaving the insulation layer 202: the fixing clip 10 may be embedded into an interior with the assistance of a manipulator (not shown in the drawing) before the fibers are crossed with each other to form the insulation layer. The weaving guide ring 203 needs to keep a certain distance from a weaving forming point 204, so that there is still a certain gap between the fibers in which the bottom portion of the fixing clip 10 may be inserted. As long as the first or second bottom portion of the fixing clip is inserted, the other bottom portion may be naturally brought in by the yarns along with weaving. A pulling speed of weaving is constant, so that the fixing clip may be embedded on time according to a pre-positioned location of the sealing strip at a time point of insertion of the fixing clip. The first bottom portion and the second bottom portion need to form an included angle less than 90 degrees with a pulling direction during inserting, and the included angle preferably ranges from 30 degrees to 60 degrees, which is not limited.

The insulation layer 202 (outer layer) of the sealing strip is always attached to the box of the equipment. In addition, a disassembly requirement of the fixing clip is also fully considered, so that the fixing clip may be conveniently disassembled at any time.

In addition to the above advantages, the fixing clip disclosed by the present invention can reduce one production process, and the fixing clip may be mounted at the same time during weaving, thus reducing a production cost of the sealing strip.

The present invention further discloses a weaving method of a sealing strip, comprising specific steps of: inserting the first bottom portion or the second bottom portion of the fixing clip into the fibers crossed with each other, and bringing the other bottom portion into the fibers by the yarns along with weaving.

The round tips of the first bottom portion and the second bottom portion of the fixing clip of the present invention both protrude towards the head portion, so that the mounting is very smooth.

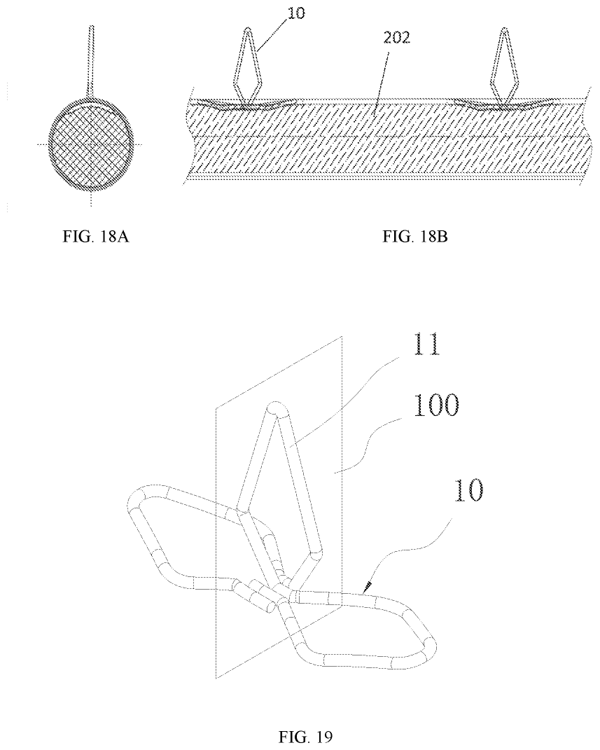

FIGS. 17A-17B are schematic structural diagrams of a hollow sealing strip, FIGS. 18A-18B are schematic structural diagrams of a solid sealing strip, and the hollow sealing strip and the solid sealing strip is both provided with a plurality of fixing clips.

The first bottom portion and the second bottom portion of the fixing clip of the present invention are symmetrically arranged, and lengths of the first bottom portion and the second bottom portion are not strictly limited, so that there is a sufficient grabbing space, which is conveniently for a user to mount the sealing strip on the oven. Mounting directions of the first bottom portion and the second bottom portion are consistent with an axial direction of the sealing strip, and once the first bottom portion and the second bottom portion are mounted, directions of the first bottom portion and the second bottom portion are fixed to avoid arbitrary rotation, so that the head portions of all fixing clips are unified in direction. The user of the sealing strip may directly grab the first bottom portion and the second bottom portion for mounting without adjusting the direction of the fixing clip.

As shown in FIG. 18, when a central plane 100 of the fixing clip 10 is taken as a reference plane (the central plane refers to the reference plane perpendicular to the plane where the head portion 10 is located), the head portion and the bottom portion (comprising the first bottom portion and the second bottom portion) are designed to be completely symmetrical, so that when the fixing clip is disassembled, a diagonal distance of the head portion can be reduced by pinching and pulling the first bottom portion and the second bottom portion (or the diagonal distance of the head portion can be reduced by compressing the first bottom portion and the second bottom portion inwardly), thus pulling the fixing clip out of the mounting hole. This mounting method will not damage the sealing strip or the clip. After many times of mounting and disassembly, the fixing clip may still be reused.

The first bottom portion and the second bottom portion are both provided with the round tip, thus being convenient for mounting while weaving. When the insulation layer of the sealing strip is woven, the yarns may be crossed with each other continuously, and the round tips of the first bottom portion and the second bottom portion are beneficial for being inserted into the insulation layer. Moreover, once the “round tips” enter the insulation layer, the “round tips” may smoothly push the surrounding fibers away to be located on the surface of the inner core of the sealing strip, and once the first bottom portion or the second bottom portion enters an inner layer of the surface, the remaining bottom portion may be naturally attached to the inner core, and this part of yarns have not yet fully formed a sufficient space in which the other bottom portion is inserted.

Once a diagonal part of the symmetrical quadrangle of the head portion of the clip is inserted into the mounting hole of the box, a pushing force towards the mounting hole is generated through a pair of shorter adjacent sides of the symmetrical quadrangle, and this pushing force will be balanced by a downward pushing force generated by the symmetrically quadrangular “round tip” of the bottom portion and an outer panel of the box, thus realizing stable fixation of bidirectional stress. Because a sealing layer is located between the head portion and the bottom portion, the sealing layer will always be firmly attached to the panel of the box under an action of the upward and downward pushing forces, and will not sag after repeated use. This bidirectional pushing force may even compensate for the problem of various apertures of the mounting hole. Because this type of hole opening is realized by a stamping process, it is inevitable that there is a certain error in size. If the bottom portion is designed to be a plane, once the aperture of the mounting hole is too large, the head portion of the clip cannot be firmly arranged in the mounting hole, leading to sagging and leakage of the sealing strip.

The fixing clip disclosed by the patent of the present invention may be embedded into the interior while weaving the outer layer of the sealing strip, so as to be integrally formed with the outer layer, which is namely the insulation layer, and the hollow and solid sealing strips may both be used, which can not only solve the shortcomings of the existing technical solution, but also reduce manual mounting after weaving, and reduce a production cost and production efficiency. The highest cost of one sealing strip lies in labor consumption for mounting the fixing clip instead of materials, so that the elimination of a labor-consuming process is equivalent to saving more than half of the production cost.

Once the bottom portion and the head portion of the fixing clip are mounted on fixing panels of an oven, a refrigerator and similar household appliances, the sealing strip may be attached to the box under the action of the bidirectional pushing force, thus avoiding sagging and loosening.

The fixing clip has a symmetrical design, which can avoid the clip from being scrapped due to damage caused by unilateral stress on the head portion during disassembly. The fixing clip is provided with the first bottom portion and the second bottom portion which are convenient to grab, and the diagonal distance of the head portion can be reduced by pulling left and right or compressing, and then the clip is pulled out without damage by easily pulling outwardly.

The bottom portion of the fixing clip is provided with a barbed tail, which will not hurt fingers of a production operator and a user. In addition, because an overall design of the bottom portion belongs to a closed loop, the fixing clips are not intertwined with each other during transportation of the clips, thus avoiding a tedious disentangling work of an operator.

The description above is only the preferred embodiments of the present invention, and is not intended to limit the present invention in any form. Although the present invention has been disclosed by the preferred embodiments above, the preferred embodiments are not intended to limit the present invention. Those skilled in the art can make some changes or modifications as equivalent embodiments with equivalent changes by using the technical contents disclosed above without departing from the scope of the technical solutions of the present invention. However, for the contents not departing from the scope of the technical solutions of the present invention, any simple amendments, equivalent changes and modifications made to the above embodiments according to the technical essence of the present invention are still included in the scope of the technical solutions of the present invention.

We claim:

1. A fixing clip formed by bending a single metal wire, wherein the fixing clip comprises a head portion, a first bottom portion and a second bottom portion; the first bottom portion and the second bottom portion are respectively connected with two ends of the head portion; the head portion is in a quadrangular diamond shape, and the head portion, the first bottom portion and the second bottom portion all comprise a round tip; and at least one of the round tip of the first bottom portion and the round tip of the second bottom portion is bent towards the round tip of the head portion.

2. The fixing clip used for a sealing strip according to claim 1, wherein the round tip of the head portion is called a head round tip; and the head portion further comprises a first head bending section connected with one end of the head round tip, a second head bending section connected with the other end of the head round tip and a first horizontal section connected with the first head bending section.

3. The fixing clip used for the sealing strip according to claim 2, wherein the round tip of the first bottom portion and the round tip of the second bottom portion are both called a bottom round tip; the first bottom portion and the second bottom portion are symmetrically arranged, and the first bottom portion and the second bottom portion both comprise a first bottom bending section connected with one side of the bottom round tip and a second bottom bending section connected with the other side of the bottom round tip; and the first bottom portion further comprises a second horizontal section connected with the second bottom bending section, and the second bottom portion further comprises a third horizontal section connected with the second bottom bending section.

4. The fixing clip used for the sealing strip according to claim 3, wherein a tail end of the first horizontal section of the head portion is connected with the first bottom bending section of the second bottom portion; and an intersection between the head portion and the first bottom portion, the first horizontal section, the second horizontal section and the third horizontal section are sequentially arranged in parallel, and the second horizontal section and the third horizontal section are two ends of the metal wire forming the fixing clip respectively.

5. The fixing clip used for the sealing strip according to claim 3, wherein the round tip of the first bottom portion and the round tip of the second bottom portion are called the bottom round tip; and the first bottom portion and the second bottom portion both comprise a first arc-shaped end and a first curved end which are connected with two ends of the bottom round tip and symmetrically arranged.

6. The fixing clip used for a sealing strip according to claim 1, wherein one end of the head portion is connected with one end of the first bottom portion in a crossed manner to form a first intersection, and the other end of the head portion is connected with one end of the second bottom portion in a crossed manner to form a second intersection; and the other end of the first bottom portion and the other end of the second bottom portion are two ends of the metal wire respectively, the other end of the first bottom portion and the other end of the second bottom portion are attached together to form a first attached part, and the first intersection, the second intersection and the first attached part are arranged in parallel and closely attached to each other.

7. The fixing clip used for a sealing strip according to claim 1, wherein two ends of the head portion are respectively connected with one end of the first bottom portion and one end of the second bottom portion in a crossed manner and form a first intersection; and the other end of the first bottom portion and the other end of the second bottom portion are two ends of the metal wire respectively, the other end of the first bottom portion and the other end of the second bottom portion are attached together to form a first attached part, a gap exists between the first intersection and the first attached part, and the gap communicates the first bottom portion with the second bottom portion.

8. The fixing clip used for a sealing strip according to claim 1, wherein two ends of the head portion are respectively connected with one end of the first bottom portion and one end of the second bottom portion in a non-crossed manner, and a joint between the head portion and the first bottom portion and a joint between the head portion and the second bottom portion are adjacent; and one end of the metal wire is the other end of the first bottom portion, the other end of the metal wire is the other end of the second bottom portion, and two opposite ends of the metal wire have a gap or are attached together.

9. The fixing clip used for the sealing strip according to claim 8, wherein at least one of the first bottom portion and the second bottom portion is provided with a protrusion extending towards the head portion.

10. A sealing strip, wherein the sealing strip is a solid or hollow sealing strip, and the sealing strip is provided with a plurality of fixing clips according to claim 1.

11. A weaving method of a sealing strip, wherein the sealing strip comprises an inner core and an insulation layer wound on the inner core, the insulation layer is formed by weaving yarns through the fixing clip according to claim 1, and the weaving method comprises: inserting the first bottom portion or the second bottom portion of the fixing clip into fibers crossed with each other, and bringing the other bottom portion into the fibers by the yarns along with weaving.

12. The weaving method of the sealing strip according to claim 11, wherein the first bottom portion and the second bottom portion form an included angle less than 90 degrees with a pulling direction during inserting.
